(19) United States
(12) Patent Application Publication
(10) Pub. No.: US 2003/0235361 A1
(43) Pub. Date: Dec. 25, 2003

(54) Polarization independent optical switch networks

(75) Inventor: Aviv Frommer, Misgav (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: LYNX PHOTONIC NETWORKS INC.

(21) Appl. No.: 10/178,739

(22) Filed: Jun. 25, 2002

(51) Int. Cl. G02B 6/35; G02B 6/27; G02B 6/28

(52) U.S. Cl. 385/16; 385/11; 385/24

(57) ABSTRACT

An architecture of, and a method for realizing polarization-independent symmetric optical networks, in particular multi-substrate PLC-implemented networks. The architecture includes, in various embodiments, at least one PM fiber performing mid-span polarization conversion in an optical path between two bi-refringement elements. At least one, and preferably two identical PM fiber sections perform the conversion by appropriate connections of their fast and slow axes to the ordinary and extraordinary axes of the bi-refringent elements.

### FIELD AND BACKGROUND OF THE INVENTION

The present invention relates to optical networks and, more particularly, to a method to realize polarization independent optical networks, comprising devices made from birefringent materials such as III-V compounds, LiNbO₃, and LiTaO₃.

In a normal single mode (SM) fiber, a signal consists of both polarizations. However, the polarization states are not maintained in a standard SM fiber. During its journey, light couples from one polarization to the other randomly. Thus, it would be highly advantageous that all the elements in an optical telecommunications network be polarization independent.

In optical telecommunications networks, both discrete and integrated optical devices are used, which are built of birefringent materials, such as the materials mentioned above. Such materials exhibit two indices of refraction of different value, an ordinary index nₒ and an extraordinary index nₑ. Optical signals that pass through these devices are subject to a split into two orthogonal polarization components that propagate one with the ordinary index nₒ, and the other with the extraordinary index nₑ. In general, the two polarization components have different travel or “passage” times. This difference causes a polarization-dependent time displacement of the signal, denominated “Polarization Mode Dispersion” (PMD).

In addition the two polarization components generally have different values of optical loss for a given optical path. The difference in optical loss of the two polarization components causes a polarization-dependent optical loss of the signal denominated “Polarization Dependent Loss” (PDL).

In particular the passage time t necessary to cover an optical path length L in a material having an index of refraction n is given by the following expression:

t=nL/c (1)

where c=3*10⁸ m/sec is the speed of light in vacuum. The difference in the passage times or the differential delay Δt of the two orthogonal polarization components having indices of refraction nₒ and nₑ in the optical path with length L is given by:

Δt=(nₒ−nₑ)L/c=ΔnL/c (2)

where Δn is the difference between the ordinary and the extraordinary indices of refraction or birefringence.

The temporal displacement between the two polarization components can degrade the optical signal with high penalties in terms of the Bit Error Rate (BER) in the case of a high value of the ΔnL product.

Integrated optical switches are well known. For a recent review of the art using LiNbO₃ substrates, see H. Nakajima, “Development on guided-wave switch arrays.” IECE Trans. Commun. Vol. E-82B, pp. 349-356, 1999. Waveguides are created in the substrate material by processing the substrate locally to increase the index of refraction. For example, the index of refraction of lithium niobate may be increased locally by diffusing titanium into the substrate. To divert light from one waveguide to another, the waveguides are coupled in a switch element by local electro-optical, therno-optical or acousto-optical manipulation of their indices of refraction. In the following, “integrated devices” and “substrates” are used interchangeably. By appropriately combining waveguides and switches, a switch matrix is formed to switch light from a plurality of input waveguides among a plurality of output waveguides. A variety of switch matrix geometries are known. In order to achieve higher port counts, several architectures have been proposed that are based on multiple interconnected substrates. These include the three-stage Clos network [C. Clos, “A study of non-blocking switching networks.” Bell System Tech. Jour., pp. 407-424, March 1953], and the two stage architecture proposed by Spanke referred to herein as the Spanke network [R. A. Spanke, “Architectures for large non-blocking optical space switches.” IEEE Jour. Quantum Electronics, Vol. QE-22, pp.964-968, 1986].

For example in a Planar Lightwave Circuit (PLC) made in x-cut lithium niobate consisting of waveguides having propagation along the y-axis (y-propagating) and thus with the optical z-axis in the plane of propagation, the TM (Transverse Magnetic) polarization component perpendicular to the plane of propagation has an ordinary index of refraction (nₒ), and the TE (Transverse Electric) polarization component parallel to the plane of propagation has an extraordinary index of refraction (nₑ). At wavelengths around 1550 nm, nₒ of LiNbO₃ is equal to about 2.226, while nₑ is about 2.154. Similar differences of the index of refraction between the TE and the TM components are observed in waveguides made for example, by diffusion of titanium in this substrate. In a device of length of about 60 mm a PMD of about 15 psec (15*10⁻¹² sec) is calculated.

In high-speed digital optical telecommunication networks working at a rate of 10 Gbps (10 Gbit/sec), the temporal distance between two successive impulses (bits) is of the order of 50 psec. A temporal displacement of 15 psec (or with a higher value in the case of concatenated devices) of the two polarization components of the same bit, induced by a birefringent device, will cause super-positions between successive bits and worsen the quality of the transmission in terms of the BER. In addition, for a device made on such a substrate, the optical loss due to absorption by the metal electrodes is for example much higher for the TM polarized light than for the TE polarized light. Differences in optical loss between the two polarization components occur also due to different losses for the different states of polarization in waveguide bends and in waveguide intersections. These loss factors add up to an overall PDL. Such PDL is highly undesirable in optical telecommunication networks since it causes differences in signal amplitude between different States Of Polarization (SOP), which can be further enhanced by other polarization dependent components included in these systems, until the amplitude of some SOPs may become lower than the system detection limit and increase the system's BER. When constructing an optical network from multiple devices made of such birefringent materials, such that multiple devices are concatenated, the PMD and PDL add up.

In view of the above-listed disadvantages of PMD and PDL in optical networks, it would be highly advantageous to have low PMD and low PDL optical networks, or in other words polarization-independent optical networks.

### SUMMARY OF THE INVENTION

The present invention is of architecture of, and a method for, realizing polarization-independent symmetric optical networks, in particular multi-substrate PLC-implemented networks. Herein, “symmetric networks” are optical networks with a symmetric topology between their inputs and outputs in terms of their PMD and PDL, i.e. networks in which the substrate interconnects are in the center of the optical path, such that the PMD and the PDL of the first section of the optical path is equal to the PMD and the PDL of the second section of the optical path. Polarization Independent Optical Switch Networks according to the present invention generally include:

a) multiple substrates of birefringent material, such that each optical path can be divided into two sections, an input section and an output section that have (i) equal PMD (an equal ΔnL product) and (ii) equal PDL.

b) a fiber interconnect section interconnecting each input section to its associated output section, and

c) one or more Polarization Maintaining (PM) fibers used for the fiber interconnection such that a PM fiber itself is used to convert the polarization between the input and the output sections.

PMD and PDL are compensated in the optical paths of the input and output sections. This happens because the polarization component TM endowed with a speed c/nₒ and with an optical loss Loss(TM) in the optical path of the input section, is converted to TE polarization between the input and the output sections, and is endowed with a speed c/nₑ and with an optical loss Loss (TE) in the optical path of the output section. Similarly, the polarization component TE endowed with a speed c/nₑ and with an optical loss Loss(TE) in the optical path of the input section, is converted to TM polarization between the input and the output sections, and is endowed with a speed c/nₒ and with an optical loss Loss (TM) in the optical path of the output section. In symmetrical optical networks, the PMD and the PDL for the input and the output sections are equal for each optical path, thus complete PMD and PDL compensation is achieved by the TE-TM conversion between the input and output sections. Degradation of the signals in terms of BER is thus avoided.

According to the present invention, there is provided in a first embodiment a substantially polarization independent optical network in which symmetry is maintained in terms of polarization dependent loss and polarization mode dispersion, comprising, a first bi-refringent optical device having at least one output port with a first ordinary axis and a first extraordinary axis, a second bi-refringent optical device having at least one input port with a second ordinary axis and a second extraordinary axis, the first and second optical devices connected along an optical path between one of the at least one input and output ports, and a polarization conversion stage that includes a polarization maintaining fiber, the fiber having a fast axis and a slow axis and configured to rotate each linear polarization component of a signal traveling along the optical path by 90°.

According to one feature of the first embodiment of the polarization independent optical network of the present invention, the configuration of the fiber to rotate each linear polarization component includes a first connection between the first device and the fiber, in which the slow axis of the fiber coincides with the first extraordinary axis of the first device, and in which the fast axis of the fiber coincides with the first ordinary axis of the first device, and a second connection between the second device and the fiber, in which the fast axis of the fiber coincides with the second extraordinary axis of the second device, and in which the slow axis of the fiber coincides with the second ordinary axis of the second device.

According to another feature of the first embodiment of the polarization independent optical network of the present invention, the configuration of the fiber to rotate each linear polarization component includes a first connection between the first device and the fiber, in which the fast axis of the fiber coincides with the first extraordinary axis of the first device, and in which the slow axis of the fiber coincides with the first ordinary axis of the first device, and a second connection between the second device and the fiber, in which the slow axis of the fiber coincides with the second extraordinary axis of the second device, and in which the fast axis of the fiber coincides with the second ordinary axis of the second device.

According to another feature of the first embodiment of the polarization independent optical network of the present invention, each of the first and second devices are selected from the group consisting of discrete devices and integrated devices.

According to the present invention, there is provided in a second embodiment a polarization independent optical network in which symmetry is maintained in terms of polarization dependent loss and polarization mode dispersion, comprising a first bi-refringent optical device having at least one output port with a first ordinary axis and a first extraordinary axis, a second bi-refringent optical device having at least one input port with a second ordinary axis and a second extraordinary axis, the first and second optical devices connected along an optical path between the at least one input and output ports, and a polarization conversion stage providing the connection along the optical path, the stage including at least two concatenated polarization maintaining fibers having equal ΔnL and configured to rotate each polarization component of a signal traveling along the optical path by 90°.

According to one feature of the second embodiment of the polarization independent optical network of the present invention, the at least two concatenated polarization maintaining fibers having equal ΔnL include two identical fibers.

According to another feature of the second embodiment of the polarization independent optical network of the present invention, the at least two concatenated polarization maintaining fibers having equal ΔnL include a first fiber having a first fast axis and a first slow axis, and a second fiber having a second fast axis and a second slow axis, and the configuration to rotate each polarization component includes a first connection between the first device and the first fiber, in which the first slow axis coincides with the first extraordinary axis and in which the first fast axis coincides with the first ordinary axis, a second connection between the first and the second fibers in which the first slow axis coincides with the second fast axis and the second slow axis coincides with the first fast axis, and a third connection between the second fiber and the second device, in which the second slow axis coincides with the second extraordinary axis, and in which the second fast axis coincides with the second ordinary axis.

According to yet another feature of the second embodiment of the polarization independent optical network of the present invention, each of the first and second devices are selected from the group consisting of discrete devices and integrated devices.

According to the present invention, there is provided in a third embodiment a polarization independent optical network in which symmetry is maintained with regard to polarization mode dispersion and polarization dependent loss, comprising an input optical section including a first plurality of first elements, each with at least one output, and an output optical section including a second plurality of second elements, each with at least one input, each of the at least one outputs of the first elements is connected by an optical path to at least one of the outputs of at least one of the second elements, each of the input and output optical sections have equal PMD and PDL for each optical path in the network, and a PM fiber based polarization conversion stage inserted in each optical path, and configured to rotate by 90° each linear polarization component of a signal traveling along each optical path.

According to one feature of the third embodiment of the polarization independent optical network of the present invention, each of the first and second elements are selected from the group consisting of discrete devices and integrated devices.

According to another feature of the third embodiment of the polarization independent optical network of the present invention, each of the integrated devices is a planar lightwave circuit device.

According to yet another feature of the third embodiment of the polarization independent optical network of the present invention, the network is further characterized in that each element of the first and second pluralities has at least one port with an ordinary and an extraordinary axis, and in that the PM fiber based polarization conversion stage includes a PM fiber that has a fast axis and a slow axis, and in that each PM fiber based polarization conversion stage includes: a first connection between an output port of the element of the first plurality and the PM fiber, in which the slow axis of the fiber coincides with the extraordinary axis of the output port of the first element, and in which the fast axis of the fiber coincides with the ordinary axis of the same output port of the first element, and a second connection between the PM fiber and the at least one input port of at least one second element, in which the fast axis of the fiber coincides with the extraordinary axis of the at least one input port of the at least one second element, and in which the slow axis of the fiber coincides with the ordinary axis of the at least one input port of the at least one second element.

According to yet another feature of the third embodiment of the polarization independent optical network of the present invention, the network is further characterized in that each element of the first and second pluralities has at least one port with an ordinary and an extraordinary axis, and in that the PM fiber based polarization conversion stage includes at least two concatenated PM fibers having equal ΔnL, each of the PM fibers having a fast axis and a slow axis.

According to yet another feature of the third embodiment of the polarization independent optical network of the present invention, the at least two concatenated PM fibers having equal ΔnL include two, first and second identical fibers, and each fiber based polarization conversion stage includes: a first connection between each port of the first element of the first plurality and the first fiber, in which the extraordinary axis of the port of the first element coincides with the slow axis of the first fiber, and in which the first ordinary axis of the port of the first element coincides with the fast axis of the first fiber, a second connection between the first and the second fibers, in which the slow axis of the first fiber coincides with the fast axis of the second fiber, and the fast axis of the first fiber coincides with the slow axis of the second fiber, and a third connection between the second fiber and the at least one port of at least one second element of the second plurality, in which the fast axis of the second fiber coincides with the ordinary axis of the at least one port of the at least one second element, and in which the slow axis of the second fiber coincides with the extraordinary axis of the at least one port of the at least one second element. According to the present invention there is provided a method for obtaining polarization independence in an optical network in which symmetry is maintained with regard to polarization mode dispersion and polarization dependent loss, comprising: providing at least two bi-refringent elements, each two of the at least two elements connected in an optical path carrying TM and TE polarized signal components, and using a PM fiber-based polarization conversion stage inserted in each optical path to rotate each polarization component by 90°, whereby the rotation yields a substantially PMD and PDL compensated network.

According to one feature of the method of the present invention for obtaining polarization independence in an optical network, the step of providing at least two bi-refringent elements includes providing a first bi-refringent optical device having at least one output port with a first ordinary axis and a first extraordinary axis, and a second bi-refringent optical device having at least one input port with a second ordinary axis and a second extraordinary axis, and the step of using a PM fiber-based polarization conversion stage includes providing a polarization maintaining fiber configured to perform the rotation.

According to another feature of the method of the present invention for obtaining polarization independence in an optical network, the step of providing at least two bi-refringent elements includes providing a first bi-refringent optical device having at least one output port with a first ordinary axis and a first extraordinary axis, and a second bi-refringent optical device having at least one input port with a second ordinary axis and a second extraordinary axis, and the step of using a PM fiber-based polarization conversion stage inserted in each optical path includes providing at least two concatenated polarization maintaining fibers having equal ΔnL and configured to perform the rotation.

According to yet another feature of the method of the present invention for obtaining polarization independence in an optical network, the substep of providing at least two concatenated polarization maintaining fibers having equal ΔnL and configured to perform the rotation includes providing two identical fibers.

### BRIEF DESCRIPTION OF THE DRAWINGS

The invention is herein described, by way of example only, with reference to the accompanying drawings, wherein:

FIG. 1 shows two birefringent elements interconnected with a PM fiber aligned against opposite polarizations of the optical components at its input and output;

FIG. 2 shows two birefringent elements interconnected with two equal lengths PM fibers interconnected such that the fast axis of one fiber is aligned against the slow axis of the second fiber;

FIG. 3 shows a multiple-substrate Spanke network incorporating the PDL and PMD compensation architecture of the present invention;

### DESCRIPTION OF THE PREFERRED EMBODIMENTS

The present invention discloses architecture of, and a method to realize a, polarization-independent switch network, and is particularly advantageous for high port count, multi-substrate networks. According to the present invention, polarization conversion is performed in symmetric (in terms of PMD and PDL) multi-substrate networks by using a PM fiber for the inter-substrate interconnect, and by performing a TE⇄TM conversion, between the input and the output sections. In one simple embodiment, the TE⇄TM conversion is performed by aligning one PM fiber's fast (F) axis against the extraordinary (E) axis of the input substrate and against the ordinary (O) axis of the output substrate, or by aligning the PM fiber's slow (S) axis against the extraordinary axis of the input substrate and against the ordinary axis of the output substrate. The two connections above can be termed respectively [(F-E/S-O)→(S-E/F-O)] and [(S-E/F-O)→(F-E/S-O)].

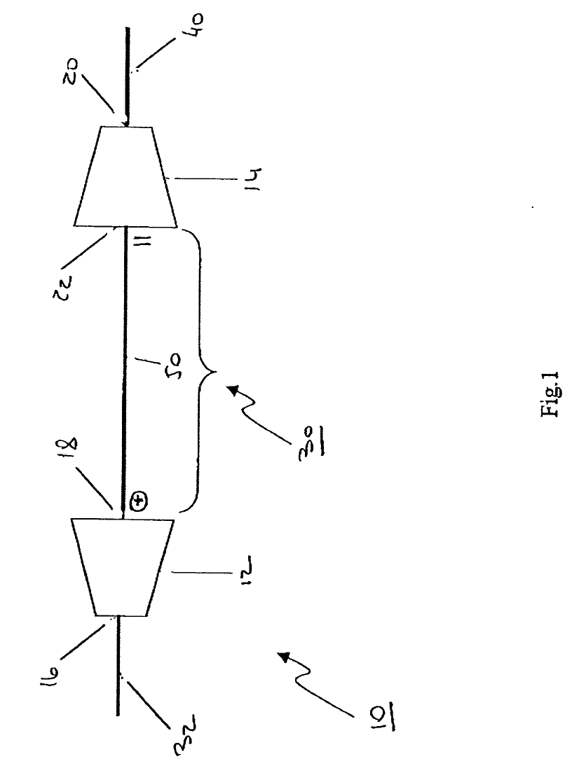

FIG. 1 shows a first embodiment of a PMD and PDL-compensated optical network 10 according to the present invention. In this specific case, network 10 comprises two identical PLC waveguide devices 12 and 14 (having typically a plurality of integrated waveguides that are not shown) made for example in an x-cut LiNbO₃ birefringent material. Devices 12 and 14 are reversible such that each of their inputs and outputs may be interchanged. For example, device 12 has an input (or output) port 16 and an output (or input) port 18, and device 14 has an input (or output) port 20 and an output (or input) port 22. Network 10 is symmetric such that devices 12 and 14 have equal PDL and equal PMD. In network 10, devices 12 and 14 are optically connected by a polarization conversion stage 30, so that port 18 (serving here as an output port) of device 12 is connected to port 22 (serving here as an input port) of device 14. An optical fiber 32 connects the outside world to port 16, which serves as an input port of the network, as well as the input of device 12. Port 20 serves as an output of device 14, as well as of network 10, being connected to the outside world by an optical fiber 40.

An incoming optical signal through fiber 32 is split into its TE and TM components at network input 16. The TM component (referred to hereafter as original TM”) travels as a TM signal along device 12 with a speed c/nₒ and a loss “Loss(TM)” associated with the TM polarization. At port 18, the original TM polarization component enters polarization conversion stage 30, and converts to TE polarization (referred to hereafter as “secondary TE”). The secondary TE component is coupled into device 14 at port 22 and travels along device 14 as a TE signal with speed c/nₑ and optical loss “Loss(TE)”. Similarly the TE component (“original TE”) entering the network travels along device 12 with TE polarization, converts to TM (“secondary TM”) in polarization conversion stage 30, and travels with TM polarization through device 14. Thus each polarization component travels half of the optical path with a TM polarization with speed c/nₒ and loss Loss(TM), and half of the optical path with a TE polarization with speed c/nₑ and loss Loss(TE). In summary, an optical signal with an arbitrary polarization entering input port 16 is split into its two orthogonal polarization components TM and TE. Each of these polarization components travels half way as TM and half way as TE. They are recombined again at network output 20, such that the PMD and PDL generated in the first half of the optical path (in device 12), are fully compensated for in the second half of the optical path (in device 14), and are essentially zero.

In prior art, such polarization conversion in mid-span has been used for PMD and PDL compensation on birefringent substrates by using two equal length chips with a quartz half plate in between, such as in a LiNbO₃ based photonic switch, see for example T. Murphy et. al., “A strictly non-blocking 16×16 electrooptic photonic switch module” ECOC'00 Munich, 2000. This method for polarization conversion however considerably complicates the manufacturing of such devices, and requires special process steps for producing the quartz half plate on the chip facet and the subsequent interconnection of the two chips. This “half-plate” method is also limited to the interconnection of only two optical chips, and is thus limited to optical devices or networks comprised of only two substrates.

In contrast with prior art “half plate” methods, the polarization conversion in the method disclosed herein and performed in stage 30 is being done with the use of at least one portion of a single mode Polarization Maintaining (PM) optical fiber 50. In the particular case shown in FIG. 1, PM optical fiber 50 is connected to output port 18 of device 12 and to input port 22 of device 14. Suitable PM optical fibers are for example those presenting elements of internal tension called “PANDA”, or those with an oval inner clad. Other PM fibers are known and can be used as well for the purposes of the present invention. The transverse cross-section of these fibers has an axis called “slow” and an axis called “fast”, the two axes perpendicular one to the other. Linearly polarized light entering either the “slow” or the “fast” optical axis of such a fiber maintains its linear polarization between the fiber's input and output.

In use, an optical signal entering system 10 for example through fiber 32 is split into its TM and TE components at the network input 16. Each polarization component then travels with its own speed and loss through one or more integrated waveguides and waveguide devices (such as switches and filters) on device 12. At port 18, PM fiber 50 is oriented (with respect to the integrated optical waveguide in which it travels on device 12) so that the slow axis of the PM fiber coincides with the extraordinary axis of device 12 and the PM fiber fast axis coincides with the ordinary axis of device 12. At port 22, the polarization components of the signal traveling on fiber 50 are aligned to device 14 oppositely: the fast axis of PM fiber 50 coincides with the extraordinary axis of device 14, and the slow axis of PM fiber 50 coincides with the ordinary axis of device 14. In other words, fiber 50 is “twisted” (polarization wise) by 90° between ports 18 and 22, “rotating” each polarization component. A polarization component traveling as a TM (TE) polarization along device 12 will travel as a TE (TM) polarization along device 14. The “twisted” PM fiber thus acts as a polarization converter.

This method of using a twisted PM fiber for performing polarization conversion in the middle of the optical path generating the PMD and PDL eliminates any special process steps for producing polarization converter 30. Specifically, the method of the present invention uses fiber interconnect 50 itself for the polarization conversion, instead of prior art half-plate and similar solutions. A major advantage of using a fiber for this purpose is that any number of substrates (chips) can be interconnected and compensated for PMD and PDL, and not only typically two as with sandwiching half-plates between two substrates. For networks in which each optical path is exactly identical and symmetric between the input and output stages, the PDL and PMD resulting from the birefringent devices 12 and 14 is fully compensated for. However there is still a residual PMD as a result of the PMD of the PM fiber itself.

In PM fibers, signals with polarization parallel to the slow axis propagate according to a first index of refraction, with a speed lower than the signals having polarization parallel to the fast axis of the fiber, that propagate according to a different value of the index of refraction. The typical birefringence of these fibers, that is the difference between the indices of refraction related to the two axes, is of the order of Δn˜0.0001−0.001. An example for a “PANDA” fiber suitable for the wavelength of 1550 nm is that of the Fujikura Firm identified by the letters SM(C) 15-P. The birefringence of the PANDA SM(C) 15-P is about Δn=4.5×10⁻⁴. If the PM fiber interconnect has a length L>1 m than the total PMD associated with the PM fiber alone is Δt=ΔnL/c>1.5 psec. In this case the PMD of the PM fiber itself has also to be compensated for high bit rate transmission.

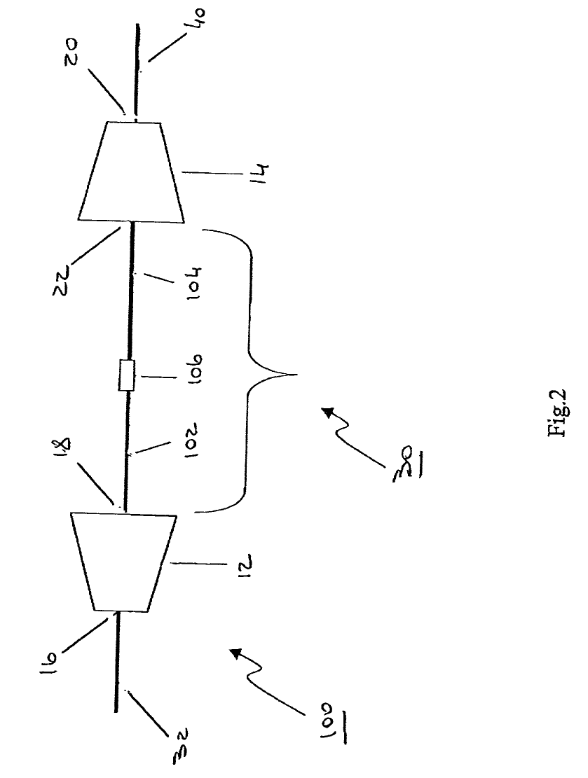

According to the present invention, the PMD due to the PM fiber interconnect can also be compensated for as shown in FIG. 2 by preferably using two PM fibers of equal ΔnL product (instead of one fiber, e.g. fiber 50 of FIG. 1) for the interconnect. Most preferably, the two-fiber section would be identical and have equal length. Alternatively, each side may be concatenated from any number of fiber sections as long as the total ΔnL product is equal on both sides of the polarization conversion interconnect.

FIG. 2 shows, in a second embodiment of the method and architecture of the present invention, an optical network 100 that is basically identical with network 10 of FIG. 1, except that PM fiber 50 is replaced by two concatenated fibers having the same ΔnL product, a first PM fiber section 102 and a second PM fiber section 104. Fibers 102 and 104 are interconnected using preferably a PM fiber connector 106, such that the fast axis of fiber 102 is aligned against the slow axis of fiber 104 and vice versa. In general, it can be stated that the connection of the first section (fiber 102) to the first substrate (device 12) is identical with the second connection of the second section (fiber 104) to the second substrate (device 14). That is, the connection between each device and its respectively connected fiber section can be written either as (F-E/S-O) or as (S-E/F-O). Since fibers 102 and 104 are chosen to be of equal ΔnL (equal PMD), their connection is a “mid-span” connection, with the attending conversion obtained by this polarization conversion stage termed “mid-span” polarization conversion. Using such “mid-span” polarization conversion, complete PMD compensation for the PMD of the PM fiber interconnect section (102+104) is achieved in the same manner described before for connecting any two birefringent elements. This effect is additional to the compensation achieved for the PMD and PDL of devices 12 and 14, which like in network 10 compensate the PMD and PDL of one another, since polarization rotation has been performed in the polarization conversion stage 30. In this case the polarization conversion in stage 30 is achieved by the polarization rotation in fiber interconnect 106.

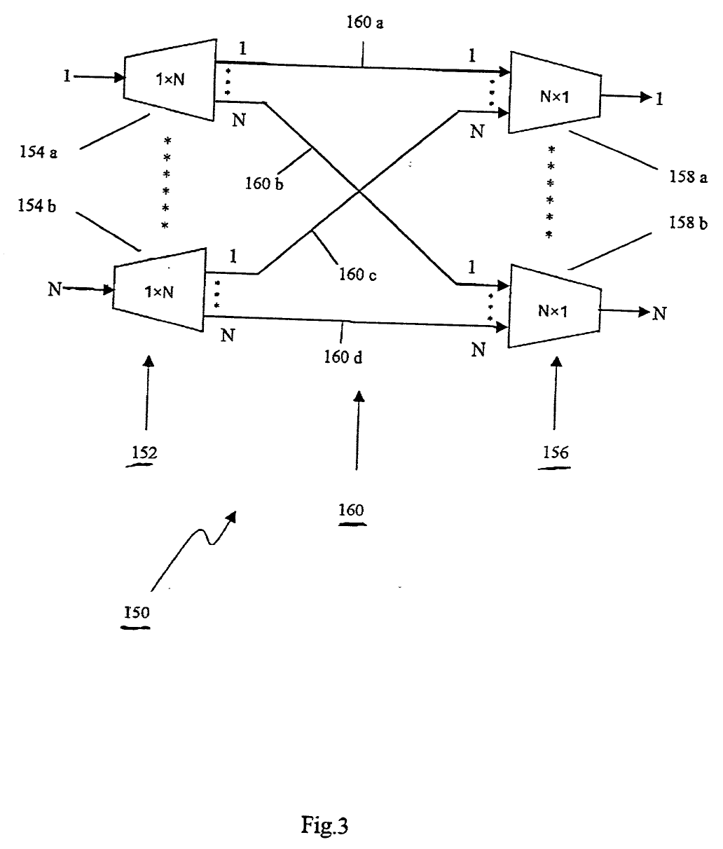

As mentioned in the example above, using the PM fiber for mid-span polarization conversion enables to interconnect a multi-substrate optical network, and achieve full PMD and PDL compensation in the case that the network topology is symmetric and the input section is identical to the output section in terms of PMD and PDL for each optical path. We call such a PMD and PDL compensated network a “polarization independent network”. In particular, according to the present invention, full PMD and PDL compensation may be achieved in the two-stage Spanke optical switching network mentioned above. As shown by example in FIG. 3, a N×N Spanke network 150 is based on partitioning the architecture over several substrates, eliminating the need for integrated optical waveguide crossovers, and allowing for large switch dimension without complex integration on individual substrates. Network 150 includes an input section 152 built of N, 1×N switches 154, and an output section 156 built from N, N×1 switches 158. Typically the numbers of input waveguides and output waveguides, both chosen to be N in this example, are equal powers of 2, up to a practical maximum of 512. In FIG. 3, only two switches 154a, b out of the N switches of input section 152, and only two switches 158a, b of the N switches of output section 156 are shown. Switches 154 a, b and 158a, b are interconnected by four fiber “substrate” interconnects 160(a-d). Only these four interconnects are shown, out of N² substrate interconnects in the N×N switch network. The network is symmetric, such that each optical path can be divided into its input section (substrate) and output section (substrate), which are identical, and in particular have identical PMD and PDL. Each substrate interconnect 160(a-d) (always a single PM fiber as in FIG. 1, or a two-section PM fiber as in FIG. 2) is in the center of the optical path between an input substrate and an output substrate, and performs TE⇄TM polarization conversion.

Such a network may be built for example from active x-cut LiNbO₃ 1×N switches. In this case the polarization of the light is maintained in each single substrate. By converting the polarization in the middle of the optical path between the two substrates, e.g. in the fiber interconnect region 160, PMD and PDL can be compensated for as explained in the example above. Specifically, for any optical path between any of the N input ports to any of the N output ports, mid-span polarization conversion is performed in the interconnect region 160, between two identical substrates in the network, and PMD and PDL are fully compensated for. That is, each optical path contains two equal length and equal loss birefringent substrates, one in the input section 152 and one in the output section 156, mid-span polarization conversion is performed in 160, such that PMD and PDL generated in 152 is compensated for in 156. The polarization conversion may be done either by using a single PM fiber like shown in FIG. 1, (in this case residual PMD due to the PM fiber itself is present) or by two equal ΔnL and preferably identical PM fibers like shown in FIG. 2 (in this case the PMD of the PM fiber itself is also compensated for).

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is

1. A substantially polarization independent optical network in which symmetry is maintained in terms of polarization dependent loss and polarization mode dispersion, comprising:
i. a first bi-refringent optical device having at least one output port with a first ordinary axis and a first extraordinary axis,
ii. a second bi-refringent optical device having at least one input port with a second ordinary axis and a second extraordinary axis, said first and second optical devices connected along an optical path between said at least one input and one output ports, and
iii. a polarization conversion stage that includes a polarization maintaining fiber, said fiber having a fast axis and a slow axis and configured to rotate each linear polarization component of a signal traveling along said optical path by 90°.

2. The network of claim 1, wherein said configuration of said fiber to rotate each linear polarization component includes;
i. a first connection between said first device and said fiber, in which said slow axis of said fiber coincides with said first extraordinary axis of said first device, and in which said fast axis of said fiber coincides with said first ordinary axis of said first device, and
ii. a second connection between said second device and said fiber, in which said fast axis of said fiber coincides with said second extraordinary axis of said second device, and in which said slow axis of said fiber coincides with said second ordinary axis of said second device.

3. The network of claim 1, wherein said configuration of said fiber to rotate each linear polarization component includes;
i. a first connection between said first device and said fiber, in which said fast axis of said fiber coincides with said first extraordinary axis of said first device, and in which said slow axis of said fiber coincides with said first ordinary axis of said first device, and
ii. a second connection between said second device and said fiber, in which said slow axis of said fiber coincides with said second extraordinary axis of said second device, and in which said fast axis of said fiber coincides with said second ordinary axis of said second device.

4. The network of claim 1, wherein each of said first and second devices are selected from the group consisting of discrete devices and integrated devices.

5. A polarization independent optical network in which symmetry is maintained in terms of polarization dependent loss and polarization mode dispersion, comprising:
a. a first bi-refringent optical device having at least one output port with a first ordinary axis and a first extraordinary axis,
b. a second bi-refringent optical device having at least one input port with a second ordinary axis and a second extraordinary axis, said first and second optical devices connected along an optical path between one of each said at least one input and output ports, and
c. a polarization conversion stage providing said connection along said optical path, said stage including at least two concatenated polarization maintaining fibers having equal ΔnL and configured to rotate each polarization component of a signal traveling along said optical path by 90°.

6. The optical network of claim 5, wherein said at least two concatenated polarization maintaining fibers having equal ΔnL include two identical fibers.

7. The network of claim 5, wherein said at least two concatenated polarization maintaining fibers having equal ΔnL include a first fiber having a first fast axis and a first slow axis and a second fiber having a second fast axis and a second slow axis, and wherein said configuration to rotate each polarization component includes:
i. a first connection between said first device and said first fiber, in which said first slow axis coincides with said first extraordinary axis, and in which said first fast axis coincides with said first ordinary axis,
ii. a second connection between said first and said second fibers, in which said first slow axis coincides with said second fast axis, and said second slow-axis coincides with said first fast axis, and
iii. a third connection between said second fiber and said second device, in which said second slow axis coincides with said second extraordinary axis, and in which said second fast axis coincides with said second ordinary axis.

8. The network of claim 5, wherein said at least two concatenated polarization maintaining fibers having equal ΔnL include a first fiber having a first fast axis and a first slow axis, and a second fiber having a second fast axis and a second slow axis, and wherein said configuration to rotate each polarization component includes:
i. a first connection between said first device and said first fiber, in which said first fast axis coincides with said first extraordinary axis, and in which said first slow axis coincides with said first ordinary axis,
ii. a second connection between said first and said second fibers, in which said first slow axis coincides with said second fast axis, and said second slow axis coincides with said first fast axis, and
iii. a third connection between said second fiber and said second device, in which said second fast axis coincides with said second extraordinary axis, and in which said second slow axis coincides with said second ordinary axis.

9. The network of claim 5, wherein each of said first and second devices are selected from the group consisting of discrete devices and integrated devices.

10. A polarization independent optical network in which symmetry is maintained with regard to polarization mode dispersion and polarization dependent loss, comprising
a. an input optical section including a first plurality of first elements, each with at least one output port
b. an output optical section including a second plurality of second elements, each with at least one input port, each of said first elements having at least one output port connected by an optical path to at least one input port of at least one of said second elements of second plurality, each of said input and output optical sections have equal PMD and PDL for each optical path in the network, and
c. a PM fiber based polarization conversion stage inserted in each said optical path, and configured to rotate by 90° each linear polarization component of a signal traveling along each said optical path.

11. The optical network of claim 10, wherein each of said first and second pluralities of elements are selected from the group consisting of discrete devices and integrated devices.

12. The optical network of claim 11, wherein each of said integrated devices is a planar lightwave circuit device.

13. The optical network of claim 10, further characterized in that each of said at least one input and output ports has an ordinary and an extraordinary axis, and in that said PM fiber based polarization conversion stage includes a PM fiber that has a fast axis and a slow axis, and wherein each said fiber based polarization conversion stage inserted in each said optical path, and configured to rotate each linear polarization component includes
i. a first connection between said first element of the first plurality and said PM fiber, in which said slow axis of said fiber coincides with said extraordinary axis of said output port of said first element, and in which said fast axis of said fiber coincides with said ordinary axis of said output port of said first element, and
ii. a second connection between said PM fiber and one of said at least one second elements, in which said fast axis of said fiber coincides with said extraordinary axis of said second element, and in which said slow axis of said fiber coincides with said ordinary axis of said second element.

14. The optical network of claim 10, further characterized in that each said element of said first and second pluralities has at least one port with an ordinary and an extraordinary axis, and in that said PM fiber based polarization conversion stage includes a PM fiber that has a fast axis and a slow axis, wherein each said fiber based polarization conversion stage inserted in each said optical path, and configured to rotate each linear polarization component includes
i. a first connection between said first element and said PM fiber, in which said fast axis of said fiber coincides with said extraordinary axis of said first element, and in which said slow axis of said fiber coincides with said ordinary axis of said first, and
ii. a second connection between said PM fiber and one of said second elements, in which said slow axis of said fiber coincides with said extraordinary axis of said input port of said second element, and in which said fast axis of said fiber coincides with said ordinary axis of said input port of said second element.

15. The optical network of claim 10, further characterized in that each said element of said first and second pluralities has at least one port with an ordinary and an extraordinary axis, and in that said PM fiber based polarization conversion stage includes at least two concatenated PM fibers having equal ΔnL, each of said PM fibers having a fast axis and a slow axis.

16. The optical network of claim 15, wherein said at least two concatenated PM fibers having equal ΔnL include two, first and second identical fibers, and wherein each said fiber based polarization conversion stage includes
i. a first connection between at least one port of each said first element of said first plurality and said first fiber, in which said extraordinary axis of said at least one port of said first element coincides with said slow axis of said first fiber, and in which said ordinary axis of said at least one port of said first element coincides with said fast axis of said first fiber,
ii. a second connection between said first and said second fibers, in which said slow axis of said first fiber coincides with said fast axis of said second fiber, and said fast axis of said first fiber coincides with said slow axis of said second fiber, and
iii. a third connection between said second fiber and at least one port of one of said second elements, in which said slow axis of said at least one port of said second fiber coincides with said extraordinary axis of said at least one port of said second element, and in which said fast axis of said at least one port of said second fiber coincides with said ordinary axis of said at least one port of said second element.

17. The optical network of claim 15, wherein said at least two concatenated PM fibers having equal ΔnL include two, first and second identical fibers, and wherein each said fiber based polarization conversion stage includes
i. a first connection between at least one port of each said first element of said first plurality and said first fiber, in which said extraordinary axis of said at least one port of said first element coincides with said fast axis of said first fiber, and in which said first ordinary axis of said at least one port of said first element coincides with said slow axis of said first fiber,
ii. a second connection between said first and said second fibers, in which said slow axis of said first fiber coincides with said fast axis of said second fiber, and said fast axis of said first fiber coincides with said slow axis of said second fiber, and
iii. a third connection between said second fiber and at least one port of one of said at least one second elements of said second plurality, in which said fast axis of said second fiber coincides with said extraordinary axis of said at least one port of said second element, and in which said slow axis of said second fiber coincides with said ordinary axis of said at least one port of said second element.

18. A method for obtaining polarization independence in an optical network in which symmetry is maintained with regard to polarization mode dispersion and polarization dependent loss, comprising
a. providing at least two bi-refringent elements, each two of said at least two elements connected in an optical path carrying TM and TE polarized signal components, and
b. using a PM fiber-based polarization conversion stage inserted in each said optical path to rotate each said polarization component by 90° whereby said rotation yields a substantially PMD and PDL compensated network.

19. The method of claim 18, wherein said step of providing at least two bi-refringent elements includes:
i. providing a first bi-refringent optical device having at least one output port with a first ordinary axis and a first extraordinary axis, and
ii. a second bi-refringent optical device having at least one input port with a second ordinary axis and a second extraordinary axis, and wherein said step of using a PM fiber-based polarization conversion stage inserted in each said optical path to rotate each said polarization component by 90° includes providing a polarization maintaining fiber configured to perform said rotation.

20. The method of claim 18, wherein said step of providing at least two bi-refringent elements includes:
i. providing a first bi-refringent optical device having at least one output port with a first ordinary axis and a first extraordinary axis, and
ii. a second bi-refringent optical device having at least one input port with a second ordinary axis and a second extraordinary axis, and wherein said step of using a PM fiber-based polarization conversion stage inserted in each said optical path to rotate each said polarization component by 90° includes providing at least two concatenated polarization maintaining fibers having equal ΔnL and configured to perform said rotation.

21. The method of claim 20, wherein said substep of providing at least two concatenated polarization maintaining fibers having equal ΔnL and configured to perform said rotation includes providing two identical fibers.
